(19) United States
(12) Patent Application Publication
(10) Pub. No.: US 2025/0158138 A1
(43) Pub. Date: May 15, 2025

(54) HIGH ENERGY ALL-SOLID-STATE BATTERY CELL

(71) Applicant: GM Global Technology Operations LLC, Detroit, MI (US)

(72) Inventors: Qili SU, Shanghai (CN); Meiyuan Wu, Shanghai (CN); Zhe Li, Shanghai (CN); Haijing Liu, Shanghai (CN)

(21) Appl. No.: 19/025,848

(22) Filed: Jan. 16, 2025

(30) Foreign Application Priority Data
Nov. 21, 2024 (CN) 2024116786291

(51) Int. Cl. H01M 10/42; H01M 4/02; H01M 4/04; H01M 4/131; H01M 4/134; H01M 4/38; H01M 4/505; H01M 4/525; H01M 4/62; H01M 10/0525; H01M 10/0562; H01M 50/431

(52) U.S. Cl. CPC H01M 10/4235; H01M 4/0435; H01M 4/131; H01M 4/134; H01M 4/386; H01M 4/505; H01M 4/525; H01M 4/623; H01M 10/0525; H01M 10/0562; H01M 50/431; H01M 2004/027; H01M 2300/0068

(57) ABSTRACT

An all-solid-state battery cell includes C cathode electrodes including a cathode active material layer arranged on at least one side of a cathode current collector, A anode electrodes including an anode active material layer and an anode current collector, and S separators comprising a sulfide membrane, where C, A, and S are integers greater than one. A lithium layer arranged between the anode current collector and the anode active material layer. The cathode active material, the anode active material, and the separator are densified prior to arranging the lithium layer and the anode current collector adjacent to the anode active material layer.

### CROSS-REFERENCE TO RELATED APPLICATIONS

This application claims the benefit of Chinese Patent Application No. 202411678629.1, filed on Nov. 21, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to all-solid-state battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

An all-solid-state battery cell includes C cathode electrodes including a cathode active material layer arranged on at least one side of a cathode current collector, A anode electrodes including an anode active material layer and an anode current collector, and S separators comprising a sulfide membrane, where C, A, and S are integers greater than one. A lithium layer arranged between the anode current collector and the anode active material layer. The cathode active material, the anode active material, and the separator are densified prior to arranging the lithium layer and the anode current collector adjacent to the anode active material layer.

In other features, the lithium layer has a thickness in a range from 2 μm to 20 μm, and the lithium layer comprises one of a continuous planar layer, a mesh layer, and a striped layer.

In other features, the anode active material layer includes silicon particles in a range from 70 to 90 wt %, a sulfide electrolyte in a range from 10 to 30 wt %, and a binder in a range from 0.1 to 5 wt %. The sulfide electrolyte comprises Li₆PS₅Cl and the binder comprises polytetrafluoroethylene (PTFE).

In other features, the cathode active material layer comprises cathode active material in a range from 68 to 90 wt %, a sulfide electrolyte in a range from 10 to 30 wt %, and a binder in a range from 0.1 to 3 wt %. The cathode active material comprises LiNiₓMn_{y}Co_{1-x-y}O₂ (where 0.95>x>0.6; y>0.05). The sulfide electrolyte comprises Li₆PS₅Cl. The binder comprises polytetrafluoroethylene (PTFE). The cathode active material is coated with LiNbO₃.

In other features, the sulfide membrane includes sulfide electrolyte, a binder, a lithium salt, and a filler. The sulfide membrane includes the sulfide electrolyte in a range from 85 to 99 wt %, the binder in a range from 1 to 10 wt %, the lithium salt in a range from 0 to 5 wt %, and the filler in a range from 0.1 to 1 wt %. The sulfide electrolyte comprises Li₆PS₅Cl. The binder comprises poly (ethylene oxide) (PEO).

A method for fabricating an all-solid-state battery cell includes supplying a first free-standing film including a cathode active material layer; supplying a second free-standing film including an anode active material layer; supplying a third free-standing film comprising a sulfide membrane; densifying the first free-standing film, the second free-standing film, and the third free-standing film; arranging a lithium layer and an anode current collector adjacent to the anode active material layer; and arranging a cathode current collector adjacent to the cathode active material layer.

In other features, the lithium layer has a thickness in a range from 2 μm to 20 μm, and the lithium layer comprises one of a continuous planar layer, a mesh layer, and a striped layer. The anode active material layer includes silicon particles in a range from 70 to 90 wt %, a sulfide electrolyte in a range from 10 to 30 wt %, and a binder in a range from 0.1 to 5 wt %.

The sulfide electrolyte comprises Li₆PS₅Cl. The binder comprises polytetrafluoroethylene (PTFE). The cathode active material layer comprises cathode active material in a range from 68 to 90 wt %, a sulfide electrolyte in a range from 10 to 30 wt %, and a binder in a range from 0.1 to 3 wt %.

In other features, the cathode active material comprises LiNiₓMn_{y}Co_{1-x-y}O₂ (where 0.95>x>0.6; y>0.05). The sulfide electrolyte comprises Li₆PS₅Cl. The binder comprises polytetrafluoroethylene (PTFE). The cathode active material is coated with LiNbO₃.

In other features, the sulfide membrane includes sulfide electrolyte in a range from 85 to 99 wt %, a binder in a range from 1 to 10 wt %, lithium salt in a range from 0 to 5 wt %, and filler in a range from 0.1 to 1 wt %. The sulfide electrolyte comprises Li₆PS₅Cl and the binder comprises poly (ethylene oxide) (PEO).

An all-solid-state battery cell for a vehicle includes C cathode electrodes comprising including a cathode active material layer arranged on at least one side of a cathode current collector. The cathode active material layer comprises cathode active material including LiNiₓMn_{y}Co_{1-x-y}O₂ (where 0.95>x>0.6; y>0.05) in a range from 68 to 90 wt %, sulfide electrolyte comprising Li₆PS₅Cl in a range from 10 to 30 wt %, and a binder comprising polytetrafluoroethylene in a range from 0.1 to 3 wt %. A anode electrodes including an anode active material layer and an anode current collector. The anode active material layer includes silicon particles in a range from 70 to 90 wt %, sulfide electrolyte including Li₆PS₅Cl in a range from 10 to 30 wt %, and a binder comprising polytetrafluoroethylene in a range from 0.1 to 5 wt %. S separators comprising a sulfide membrane, where C, A, and S are integers greater than one. The sulfide membrane includes sulfide electrolyte including Li₆PS₅Cl, a binder including poly (ethylene oxide) (PEO), a lithium salt, and a filler. A lithium layer arranged between the anode current collector and the anode active material layer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of an all-solid-state battery cell including C cathode electrodes, A anode electrodes, and S separators according to the present disclosure;

FIG. 2A is a side cross section illustrating an example of an anode electrode, a cathode electrode, and a separator of the all-solid-state battery cell according to the present disclosure;

FIGS. 2B and 2C are plan views of a lithium layer arranged on an anode current collector according to the present disclosure;

FIG. 3 illustrates an example of a method for manufacturing a portion of the all-solid-state battery cell using free-standing anode electrodes, cathode electrodes, and separators according to the present disclosure;

FIG. 4 is a graph illustrating an example of voltage as a function of capacity for the all-solid-state battery cell when prelithiation of the anode electrode is performed before densification with the cathode electrodes and separators;

FIG. 5 is a graph illustrating an example of voltage as a function of capacity for the all-solid-state battery cell when densification of the anode active material layer, the separator, and the cathode active material layer is performed before stacking with a lithium layer arranged on an anode current collector according to the present disclosure;

FIG. 6 is a graph illustrating an example of voltage as a function of capacity for the all-solid-state battery cell during first cycle charge/discharge according to the present disclosure;

FIG. 7 is a graph illustrating an example of capacity retention percentage as a function of cycle number for a single layer pouch cell at room temperature according to the present disclosure; and

FIG. 8 is a graph illustrating an example of capacity retention percentage as a function of cycle number for a single layer pouch cell at high temperature according to the present disclosure.

In the drawings, reference numbers may be reused to identify similar and/or identical elements.

### DETAILED DESCRIPTION

While battery cells according to the present disclosure are shown in the context of battery modules and/or packs for electric vehicles, the battery cells can be used in battery modules and/or packs for stationary applications and/or other applications.

The present disclosure relates to a sulfide-based, all-solid-state battery cell. The battery cell includes a dry cathode film, a sulfide membrane, and a dry anode film that are densified prior to being arranged adjacent to a lithium layer and an anode current collector. Using this approach, favorable lithium ion transport at particle-to-particle interfaces and layer-to-layer interfaces is achieved.

A lithium foil layer located on the anode current collector (e.g., copper foil) is bonded to the anode electrode film to offset active lithium loss and enhance cell cycling ability. The lithium/anode current collector offsets the loss of the solid electrolyte interface (SEI) between silicon of the anode electrode and sulfide electrolyte of the separator.

A prototype pouch battery cell manufactured as described herein delivered high capacity retention (e.g., greater than 80% over 1750 cycles at a 1 C current rate). With this level of performance, the battery cell according to the present disclosure enables all-solid-state battery cells for automotive applications.

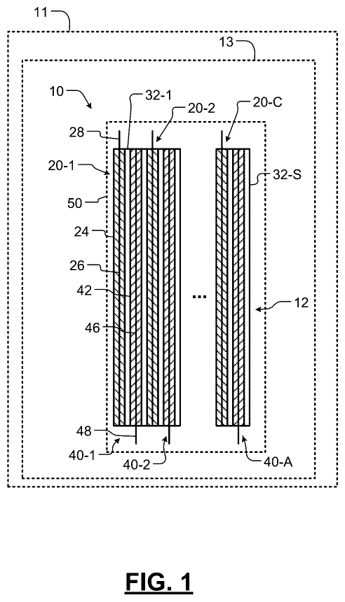

Referring now to FIG. 1, an all-solid-state battery cell 10 according to the present disclosure includes C cathode electrodes 20, A anode electrodes 40, and S separators 32 arranged in a predetermined sequence in a battery cell stack 12, where C, S and A are integers greater than zero. In some examples, a vehicle 11 includes a battery module or pack 13 that includes the battery cell 10.

The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include an anode active material layer 42 arranged on an anode current collector 46.

During charging/discharging, the A anode electrodes 40 and the C cathode electrodes 20 exchange lithium ions. In some examples, the cathode active material layers 24 and/or anode active material layers 42 comprise coatings including one or more active materials, solid electrolyte, one or more conductive additives, and/or one or more binder materials.

In some examples, the cathode current collector 26 comprises metal foil, metal mesh, perforated metal, 3 dimensional (3D) metal foam, and/or expanded metal. In some examples, the cathode current collector 26 is made of one or more materials selected from a group consisting of stainless steel, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

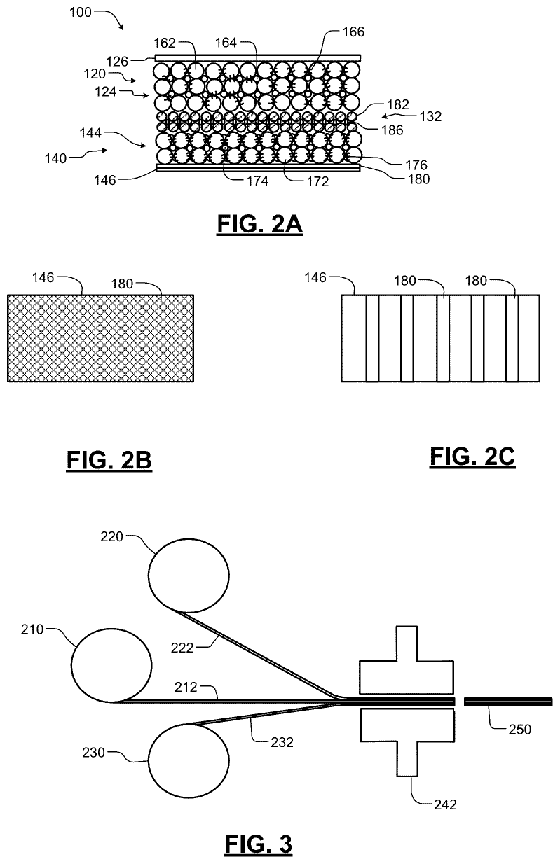

Referring now to FIGS. 2A to 2C, an all-solid-state battery cell 100 includes a cathode electrode 120, an anode electrode 140, and a separator 132. The cathode electrode 120 includes a cathode active material layer 124 arranged adjacent to one or both sides of a cathode current collector 126. The cathode active material layer 124 includes cathode active material 162, sulfide electrolyte 164, and a binder 166.

The anode electrode 140 includes an anode active material layer 144 arranged adjacent to one or both sides of an anode current collector 146. The anode active material layer 144 includes anode active material 172, sulfide electrolyte 174, a binder 176. The anode active material layer 144 further includes a lithium layer 180 arranged between the anode current collector 146 and the anode active material 172 after densification. In some examples, the separator 132 includes sulfide electrolyte 182 and a binder 186.

In some examples, the lithium layer 180 includes foil made of pure lithium. In some examples, the lithium layer 180 has a thickness in a range from 2 μm to 20 μm (e.g., 10 μm). In some examples, the lithium layer 180 includes a continuous layer (FIG. 2A). In other examples, the lithium layer 180 includes a mesh layer (FIG. 2B) or the lithium layer 180 has a striped pattern (FIG. 2C) separated by regions without the lithium layer 180.

In some examples, the anode current collector 146 includes an electrochemically inactive material selected from a group consisting of stainless steel, nickel, iron, titanium, copper, combinations thereof, and/or other conductive materials. In some examples, the anode current collector 146 has a thickness in a range from 4 μm to 30 μm (e.g., 14 μm). In some examples, the anode current collector 146 has a rough, mesh, or flat surface.

In some examples, the anode active material 172 includes silicon particles. In some examples, the silicon particles are micro-sized. In some examples, the silicon particles have a D50 particle size in a range from 1 μm to 12 μm (e.g., 3.7 μm). In some examples, the anode active material 172 has a capacity in a range from 3000 to 3600 mAh/g (0.1 C) (e.g., 3100 mAh/g). In some examples, Brunauer-Emmett-Teller (BET) is in a range from 1 m²/g to 10 m²/g (e.g., 4 m²/g).

In some examples, the anode active material layer 144 includes the silicon particles mixed with the sulfide electrolyte 174 and the binder 176. In some examples, the anode active material layer 144 includes silicon particles in a range from 70 to 90 wt %, sulfide electrolyte in a range from 10 to 30 wt %, and binder in a range from 0.1 to 5 wt % (e.g., 70/29/1 wt %). In some examples, the sulfide electrolyte 174 includes Li₆PS₅Cl. In some examples, the binder 176 includes polytetrafluoroethylene (PTFE). In some examples, the anode active material layer 144 has a thickness in a range from 5 μm to 100 μm (e.g., 20 μm). In some examples, areal loading is in a range from 4 mAh/cm² to 20 mAh/cm² (e.g., 10.1 mAh/cm²).

In some examples, the cathode active material 162 comprises LiNiₓMn_{y}Co_{1-x-y}O₂ (where 0.95>x>0.6; y≥0.05) (e.g., LiNi_{0.7}Mn_{0.2}Co_{0.1}O₂). In some examples, the cathode active material has a D50 particle size in a range from 2 μm to 10 μm (e.g., 3.8 μm). In some examples, the cathode active material 162 has a capacity in a range from 140 to 200 mAh/g (0.1 C) (e.g., 3100 mAh/g). In some examples, the BET parameter is in a range from 0.1 m²/g to 1 m²/g (e.g., 0.52 m²/g). In some examples, tap density is in a range from 1.5 to 2.0%. In some examples, the cathode active material is coated with LiNbO₃. In some examples, the LiNbO₃ coating comprises 0.5 wt % to 5 wt % of the cathode active material layer (e.g., 1 wt %).

In some examples, the cathode active material layer 124 includes the cathode active material 162, the sulfide electrolyte 164, an optional conductive filler, and the binder 166. In some examples, the cathode active material layer 124 includes the cathode active material 162 in a range from 68 to 90 wt %, the sulfide electrolyte 164 in a range from 10 to 30 wt %, the conductive filler in a range from 0 to 4 wt %, and the binder 166 in a range from 0.1 to 3 wt % (e.g., 70/29/1 wt %). In some examples, the sulfide electrolyte 164 includes Li₆PS₅Cl. In some examples, the binder 166 includes PTFE. In some examples, the cathode active material layer 124 has a thickness in a range from 100 μm to 400 μm (e.g., 200 μm). In some examples, areal loading is in a range from 4 to 10 mAh/cm² (e.g., 4 mAh/cm²).

In some examples, the separator 132 includes a sulfide membrane. In some examples, the sulfide membrane includes sulfide electrolyte, a binder, a lithium salt, and a filler. In some examples, the sulfide membrane includes solid sulfide electrolyte in a range from 85 to 99 wt %, the binder in a range from 1 to 10 wt %, the lithium salt in a range from 0 to 5 wt %, and the filler in a range from 0.1 to 1 wt % (e.g., 95/5/0.5.0.2 wt %). In some examples, the binder includes poly (ethylene oxide) (PEO). In some examples, the sulfide electrolyte includes Li₆PS₅Cl. In some examples, the separator 132 has a thickness in a range from 20 μm to 80 μm (e.g., 60 μm). In some examples, the separator 132 has an ionic conductivity in a range from 0.1 to 2 mS/cm at 30° C. (e.g., 0.2 mS/cm). In some examples, the N/P ratio is in a range from 1.1 to 4.0 (e.g., 2.52).

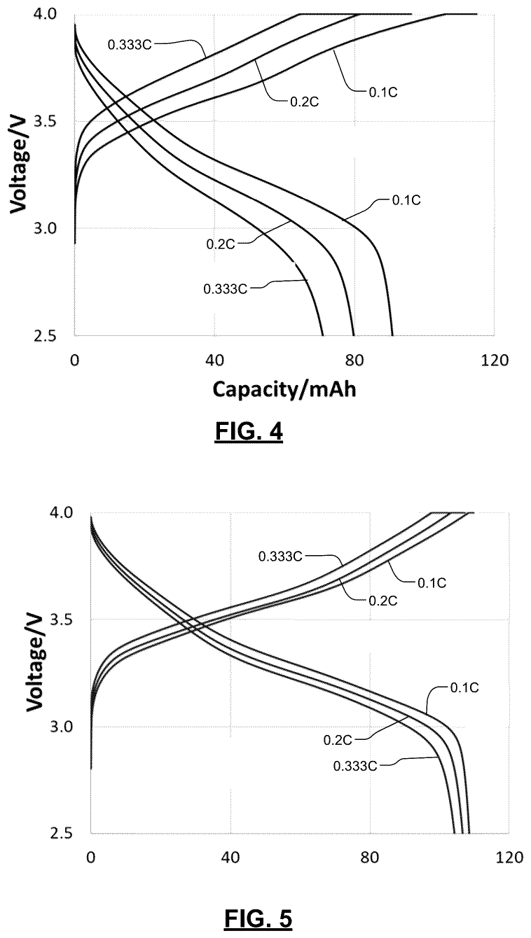

Referring now to FIG. 3, a method for manufacturing a portion of all-solid-state battery cell is shown. A roll 230 supplies a free-standing anode electrode 232 between a pressing machine 242. A roll 220 supplies a free-standing cathode electrode 222 between the pressing machine 242. A roll 210 supplies a free-standing separator 212 between the pressing machine 242. The pressing machine 222 can include an isostatic press, a hot isostatic press, or a calendaring machine. The free standing films are pressed to form a laminate 250 by applying pressure and/or heat. After densification, the lithium layer 180 and the anode current collector 146 are arranged adjacent to (or bonded to) the anode active material layer 144 and the cathode current collector 146 is arranged adjacent to (or bonded to) the cathode active material layer 124.

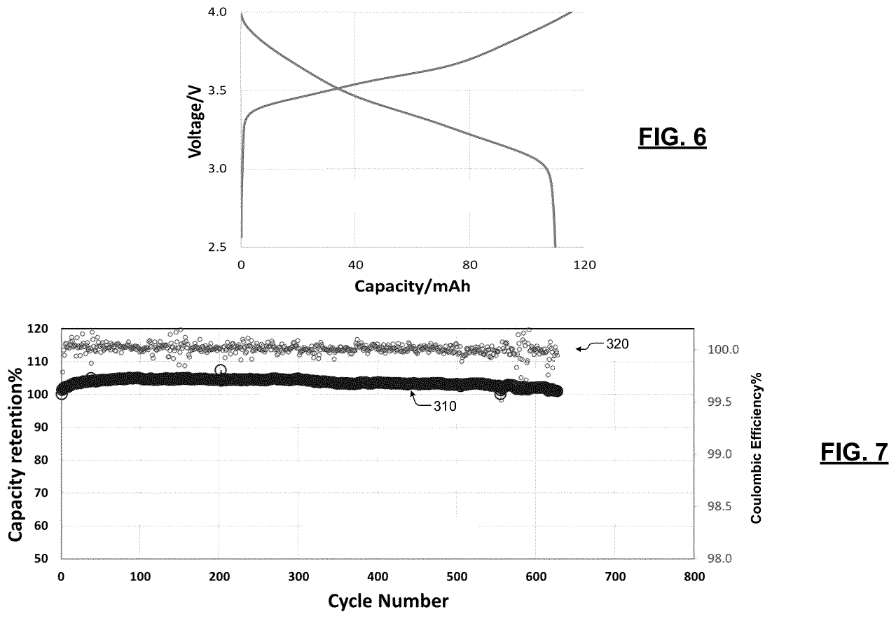

Referring now to FIGS. 4 and 5, differences in when densification and pre-lithiation occurs are shown. In FIG. 4, voltage is shown as a function of capacity at 60° C. for the all-solid-state battery cell when anode electrode prelithiation is performed. In other words, the free-standing anode active material layer 144 is arranged adjacent to the lithium layer 180 and the anode current collector 146 and densified (e.g., before the separator 132 and the cathode electrode 120 are stacked and densified to form the battery cell).

In FIG. 5, voltage is shown as a function of capacity at 60° C. for the all-solid-state battery cell when the free-standing anode active material layer, the separator, and the cathode active material layer are stacked and densified (without the cathode current collector 126, the lithium layer 180 and the anode current collector 146). S can be appreciated, the cathode current collector 126 can be arranged adjacent to the cathode active material layer prior to densification. As can be seen from FIGS. 4 and 5, the all-solid-state battery cell in FIG. 5 benefits from improved particle-to-particle ion transport, power capability, and capacity delivery.

Referring now to FIG. 6, voltage as a function of capacity is shown for the all-solid-state battery cell during first cycle charge/discharge (e.g., at 0.05 C/0.05 C). The battery cell includes NMC721 and has a discharge capacity of 160.7 mAh/g. The first cycle Coulombic efficiency is 95.2%.

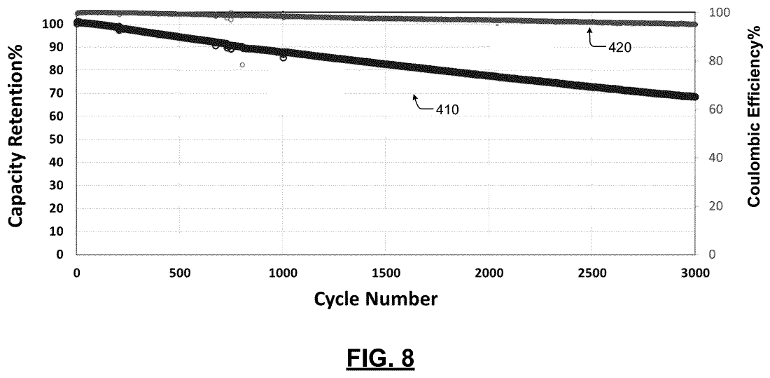

Referring now to FIG. 7, capacity retention percentage 310 and Coulombic efficiency 320 are shown as a function of cycles during cycling at room temperature (e.g., 0.333 C at 30° C.). The capacity retention after 627 cycles at C/3 is 100.9% at room temperature. In FIG. 8, capacity retention 410 and Coulombic efficiency 420 are shown as a function of cycles at 1 C at 60° C. (with a current density of 4 mA/cm²). The battery cell has 80% capacity retention at 1750 cycles.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. An all-solid-state battery cell comprising:
C cathode electrodes including a cathode active material layer arranged on at least one side of a cathode current collector;
A anode electrodes including an anode active material layer and an anode current collector;
S separators comprising a sulfide membrane, where C, A, and S are integers greater than one; and
a lithium layer arranged between the anode current collector and the anode active material layer, wherein the cathode active material, the anode active material, and the separator are densified prior to arranging the lithium layer and the anode current collector adjacent to the anode active material layer.

2. The all-solid-state battery cell of claim 1, wherein:
the lithium layer has a thickness in a range from 2 μm to 20 μm, and
the lithium layer comprises one of a continuous planar layer, a mesh layer, and a striped layer.

3. The all-solid-state battery cell of claim 1, wherein the anode active material layer includes silicon particles in a range from 70 to 90 wt %, a sulfide electrolyte in a range from 10 to 30 wt %, and a binder in a range from 0.1 to 5 wt %.

4. The all-solid-state battery cell of claim 3, wherein:
the sulfide electrolyte comprises Li₆PS₅Cl; and
the binder comprises polytetrafluoroethylene (PTFE).

5. The all-solid-state battery cell of claim 1, wherein the cathode active material layer comprises cathode active material in a range from 68 to 90 wt %, a sulfide electrolyte in a range from 10 to 30 wt %, and a binder in a range from 0.1 to 3 wt %.

6. The all-solid-state battery cell of claim 5, wherein:
the cathode active material comprises LiNiₓMn_{y}Co_{1-x-y}O_{z} (where 0.95>x≥0.6; y≥0.05);
the sulfide electrolyte comprises Li₆PS₅Cl; and
the binder comprises polytetrafluoroethylene (PTFE).

7. The all-solid-state battery cell of claim 6, wherein the cathode active material is coated with LiNbO₃.

8. The all-solid-state battery cell of claim 1, wherein the sulfide membrane includes sulfide electrolyte, a binder, a lithium salt, and a filler.

9. The all-solid-state battery cell of claim 8, wherein the sulfide membrane includes the sulfide electrolyte in a range from 85 to 99 wt %, the binder in a range from 1 to 10 wt %, the lithium salt in a range from 0 to 5 wt %, and the filler in a range from 0.1 to 1 wt %.

10. The all-solid-state battery cell of claim 9, wherein:
the sulfide electrolyte comprises Li₆PS₅Cl; and
the binder comprises poly (ethylene oxide) (PEO).

11. A method for fabricating an all-solid-state battery cell, comprising:
supplying a first free-standing film including a cathode active material layer;
supplying a second free-standing film including an anode active material layer;
supplying a third free-standing film comprising a sulfide membrane;
densifying the first free-standing film, the second free-standing film, and the third free-standing film;
arranging a lithium layer and an anode current collector adjacent to the anode active material layer; and
arranging a cathode current collector adjacent to the cathode active material layer.

12. The method of claim 11, wherein:
the lithium layer has a thickness in a range from 2 μm to 20 μm, and
the lithium layer comprises one of a continuous planar layer, a mesh layer, and a striped layer.

13. The method of claim 11, wherein the anode active material layer includes silicon particles in a range from 70 to 90 wt %, a sulfide electrolyte in a range from 10 to 30 wt %, and a binder in a range from 0.1 to 5 wt %.

14. The method of claim 13, wherein:
the sulfide electrolyte comprises Li₆PS₅Cl; and
the binder comprises polytetrafluoroethylene (PTFE).

15. The method of claim 11, wherein the cathode active material layer comprises cathode active material in a range from 68 to 90 wt %, a sulfide electrolyte in a range from 10 to 30 wt %, and a binder in a range from 0.1 to 3 wt %.

16. The method of claim 15, wherein:
the cathode active material comprises LiNiₓMn_{y}Co_{1-x-y}O_{z} (where 0.95>x≥0.6; y≥0.05);
the sulfide electrolyte comprises Li₆PS₅Cl; and
the binder comprises polytetrafluoroethylene (PTFE).

17. The method of claim 16, wherein the cathode active material is coated with LiNbO₃.

18. The method of claim 11, wherein the sulfide membrane includes sulfide electrolyte in a range from 85 to 99 wt %, a binder in a range from 1 to 10 wt %, lithium salt in a range from 0 to 5 wt %, and filler in a range from 0.1 to 1 wt %.

19. The all-solid-state battery cell of claim 18, wherein:
the sulfide electrolyte comprises Li₆PS₅Cl; and
the binder comprises poly (ethylene oxide) (PEO).

20. An all-solid-state battery cell for a vehicle, comprising:
C cathode electrodes comprising including a cathode active material layer arranged on at least one side of a cathode current collector,
wherein the cathode active material layer comprises cathode active material including LiNiₓMn_{y}Co_{1-x-y}O₂ (where 0.95>x>0.6; y>0.05) in a range from 68 to 90 wt %, sulfide electrolyte comprising Li₆PS₅Cl in a range from 10 to 30 wt %, and a binder comprising polytetrafluoroethylene in a range from 0.1 to 3 wt %;
A anode electrodes including an anode active material layer and an anode current collector,
wherein the anode active material layer includes silicon particles in a range from 70 to 90 wt %, sulfide electrolyte including Li₆PS₅Cl in a range from 10 to 30 wt %, and a binder comprising polytetrafluoroethylene in a range from 0.1 to 5 wt %;
S separators comprising a sulfide membrane, where C, A, and S are integers greater than one,
wherein the sulfide membrane includes sulfide electrolyte including Li₆PS₅Cl, a binder including poly (ethylene oxide) (PEO), a lithium salt, and a filler; and
a lithium layer arranged between the anode current collector and the anode active material layer.
